(19) United States
(12) Patent Application Publication
(10) Pub. No.: US 2017/0300968 A1
(43) Pub. Date: Oct. 19, 2017

(54) METHOD AND SYSTEM FOR DISSEMINATING INFORMATION OVER A COMMUNICATION NETWORK

(71) Applicant: NB Portals, LLC, Potomac, MD (US)

(72) Inventor: Robert E. Reiver, Potomac, MD (US)

(21) Appl. No.: 15/099,242

(22) Filed: Apr. 14, 2016

(51) Int. Cl. G06Q 30/02

(52) U.S. Cl. CPC G06Q 30/0256; G06Q 30/0272; G06Q 30/0259; G06Q 30/0261

(57) ABSTRACT

A website-enabled method for disseminating promotional information to consumers in real time over a communication network. According to methods and systems described herein, a retail promotional platform may store one or more promotions submitted by retail merchants. Consumers may then search the retail promotional platform via a website or a mobile device portal application to receive, via the communication network, relevant promotional information, such as promotions that are in a specified geography, in a specified shopping center, or for a specified retail merchant.

### TECHNICAL FIELD

The present disclosure relates generally to methods and systems for disseminating promotional information in real time over a communication network.

### BACKGROUND

Consumers are plagued with information, including, retail marketing, advertisement and promotional information. In a lot of cases, the retail information is of little value to a modern consumer who is short on time and unable to travel from store to store across a large geographical area, or even to drive miles to a specific store to take advantage of a specific promotion. In addition, the retail information may not be relevant to a consumer's buying preferences or the consumer may be unable to make use of promotional information while the information is valid, such as prior to expiration of a promotion. Further, some brick-and-mortar retail stores have trouble competing with online retailers because online retailers are able to disseminate promotional information to consumers as a consumer browses online for specific items or at specific retailers, in real time.

In addition, when retail promotions and sales are discussed, the focus is usually on the retail merchant and the consumer. Another stakeholder in the retail environment is the landlord of the retail merchant or the manager of the shopping center who has a vested interest in promoting its tenants' businesses and driving consumers to the retailers on their premises. Many commercial landlords of this type typically fund a budget for promoting the retail goods and services of its tenants. To the modern consumer, the focus is generally on the individual retailer or store, and not as much on the shopping center as a whole. Aspects of the present disclosure may also be employed by a commercial shopping center manager to disseminate retail promotional information of its tenants so as to entice consumers to frequent a particular shopping center. Once a consumer arrives at a shopping center, even if the motive was a particular retailer for a particular product or service, the consumer is apt to browse other retailers in the same center and potentially acquaint themselves with other retailers or purchase goods or services they had not initially planned to purchase.

### SUMMARY

In one aspect, the disclosure provides a method for disseminating promotional information to a consumer over a communication network. According to the disclosure, the method comprises receiving, by a server configured to process promotional data as part of a promotional information dissemination system, at least one promotion, where the at least one promotion is associated with a retail merchant and a first parameter. The method further comprises storing, by the server in a searchable database connected to the promotional information dissemination system, the at least one promotion, the associated retail merchant and the first parameter. The method also comprises receiving, by the server, a query for retail promotional information from an access device configured to interact with the promotional information dissemination system. In addition, the method comprises searching, by the server, the searchable database based on the query and sending, by the server, the at least one retail promotion to the access device.

In another aspect, the disclosure provides a system for disseminating retail promotional information to a consumer. In particular, the system comprises a retail promotional system portal application, executing on a mobile device of a consumer, a retail promotional system database, and a retail promotional system server in network communication with the retail promotional system portal application and the retail promotional system database. According to the disclosure, the retail promotional system server may be configured to receive data related to the consumer, and then send a promotion to the retail promotional system portal application, based on the data related to the consumer. The retail promotional system server may further be configured to determine whether an event has happened for the promotion to be deleted, and then delete the promotion from the retail promotional system portal application if the event has happened.

In yet another aspect the invention provides a method for disseminating promotional information to a consumer over a communication network. The method may comprise receiving, by a retail promotional system server, data related to a consumer from a web-based service. The consumer may have access to a retail promotional system portal application on a mobile device, which is in communication with the retail promotional system server. Next, based on the data related to the consumer, the retail promotional system server may determine that a promotion is relevant to the consumer, and according to the method may send the promotion to the retail promotional system portal application. Further, the retail promotional system may determine whether an event has happened for the promotion to be deleted, if the event has happened, delete the promotion from the retail promotional system portal application.

Other systems, methods, features and advantages of the present disclosure will be, or will become, apparent to one of ordinary skill in the art upon examination of the following figures and detailed description. It is intended that all such additional systems, methods, features and advantages be included within this description and this summary, be within the scope of the present disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 depicts an embodiment of a retail promotional platform system;

FIG. 2 depicts a network environment in which aspects of the present disclosure may be implemented;

FIG. 3 depicts a flowchart of a method for disseminating promotional information, according to an embodiment of the present disclosure;

FIG. 4 depicts an electronic format for entering promotional information, according to an embodiment of the present disclosure;

FIG. 5 depicts an example data record for storing promotional information, according to an embodiment of the present disclosure;

FIG. 6 depicts a portal application user interface, according to an embodiment of the present disclosure;

FIG. 7 depicts a web-based user interface, according to an embodiment of the present disclosure;

FIG. 8 depicts a flowchart of a method for disseminating promotional information, according to another embodiment of the present disclosure;

FIG. 9 depicts a flowchart of a method for deleting promotional information from a mobile device, according to an embodiment of the present disclosure;

FIG. 10 depicts an example of the methods for disseminating and deleting promotional information from a mobile device, according to an embodiment of the present disclosure;

FIG. 11 depicts a flowchart of a method for disseminating promotional information, according to another embodiment of the present disclosure; and

FIG. 12 depicts a flowchart of a method for disseminating promotional information, according to yet another embodiment of the present disclosure.

### DETAILED DESCRIPTION

Embodiments of the present disclosure respond to a consumer's need to receive, as well as a shopping center's or a merchant's desire to deliver, retail promotional material that is relevant to the particular consumer and is delivered in real time when needed. As set forth in more detail below, one or more embodiments provide that retail promotional material may be disseminated according to a variety parameters, including, promotions that are specific to a geographical area, promotions that are specific to a specified shopping center—such as a specific retail shopping center housing a variety of retail merchants—or promotions that are specific to a particular merchant. More specifically, according to embodiments of the present disclosure, using a website-based or a portal application for a mobile device, a consumer may search a retail promotional platform for current coupons or promotions being offered by a particular retail merchant, in a specified retail shopping center, or within a specified geographical area. In other embodiments, a retail promotional platform may push to a consumer's mobile device, in real time, promotional information for selected merchants or shopping centers, or other retail-oriented parameter, when the consumer is in a pre-determined proximity to the merchant or shopping center. For purposes of the present disclosure, “real time” refers to the processing of electronic data such that it is available virtually immediately or within seconds. In still other embodiments, a consumer may configure the portal application to delete or clear promotional information that is no longer valid or has expired, or that is outside of a specific geographical area, saving space and facilitating efficient operation of the mobile device. These and other embodiments will be discussed in more detail in the following paragraphs.

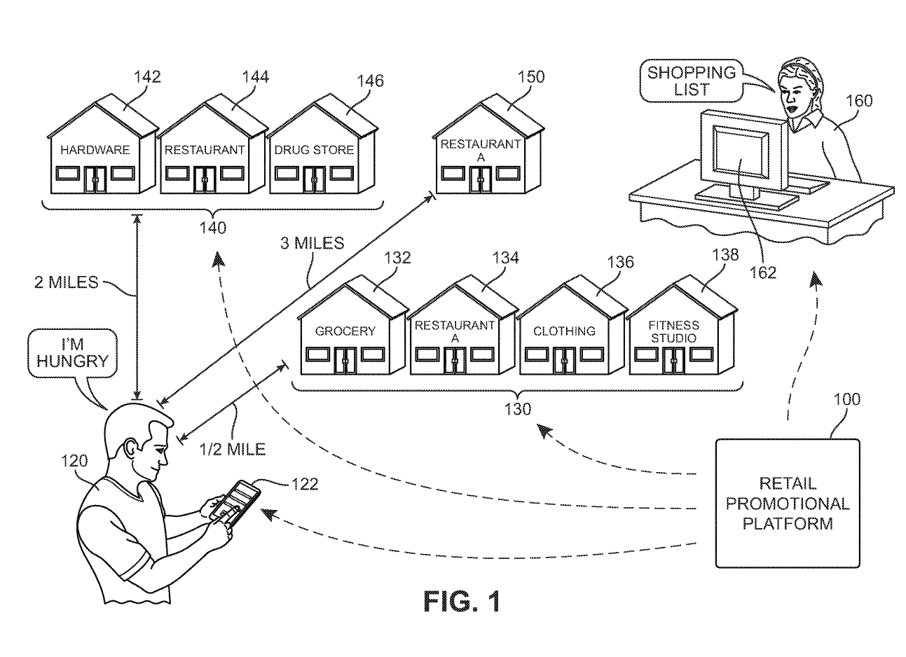

FIG. 1 is a simplified depiction of a retail promotional platform 100 in use according to embodiments described herein. Referring to FIG. 1, retail promotional platform 100, which is described in more detail in the following paragraphs, may be connected to a plurality of shopping centers, merchants and consumers via a wired or wireless connection. Specifically, in the depiction of FIG, 1, and by example only, retail promotional platform 100 is connected to shopping center 130 which includes as tenants, grocery 132, Restaurant A 134, clothing merchant 136, and fitness studio 138. Retail promotional platform 100 is also connected to shopping center 140, including as tenants hardware merchant 142, restaurant 144 and drug store 146. Retail promotional platform 100 may also be connected to a merchant that is not part of a shopping center with other merchants or is otherwise a standalone entity, such as Restaurant A 150. For exemplary purposes only, Restaurant A 134 and Restaurant A 150 are different locations of the same restaurant chain, whereas restaurant 144 is a local restaurant with no other location.

According to embodiments further described herein and using the example retail environment depicted in FIG. 1, a mobile consumer 120 may access retail promotional platform 100 via mobile device 122, which may include a wireless and a wired network connection to retail promotional platform 100. Consumer 160 may also access retail promotional platform 100 via a networked device, such as home computer 162, which also may include a wireless and/or a wired network connection to retail promotional platform 100. Consumer 120 and consumer 160 may access and search retail promotional platform 100 to discover promotions at shopping center 130, shopping center 140, and/or restaurant 150. Consumer 120 and consumer 160 may also receive real time promotional information from retail promotional platform 100 via promotions that are pushed to device 122 or home computer 162 based on one or more saved preferences. These and other embodiments will be described in more detail in the following paragraphs of the description.

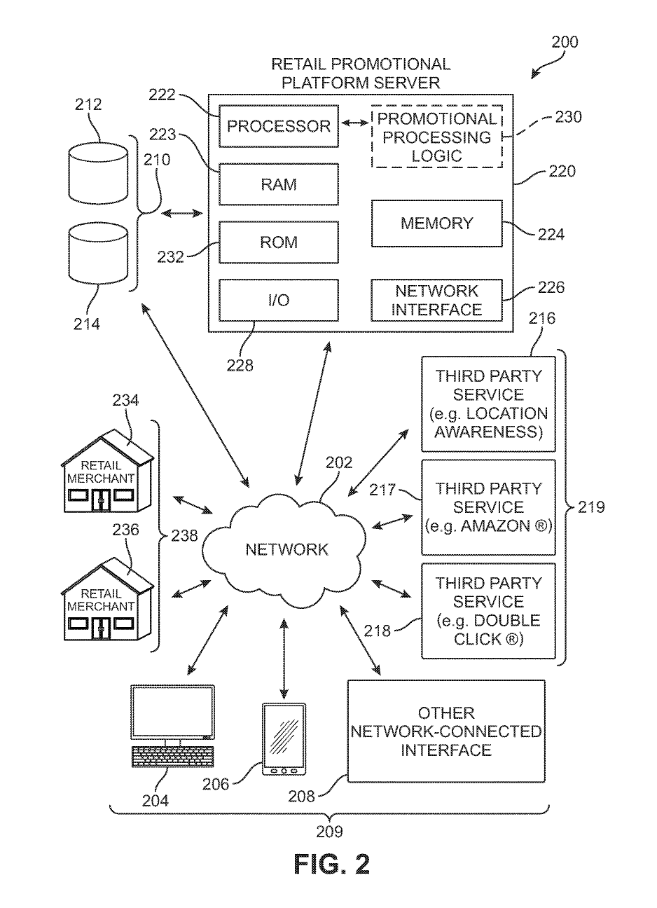

Embodiments of the methods and system described herein may utilize various computer software and hardware components, including but not limited to, servers, desktops computers, databases, computer-readable media, input/output devices, wired and wireless networking components and other components as would be known and understood by a person skilled in the art. FIG. 2 illustrates a networked operating environment 200 in which aspects of the present disclosure may be implemented, according to one or more embodiments described herein

As depicted in environment 200, retail promotional platform 100 may include one or more servers, such as retail promotional platform server 220, and one or more databases such as database 212 and database 214, collectively, databases 210. Further, connected to retail promotional platform server 220 and/or databases 210 may be: one or more access devices, such as computer/laptop computer 204, handheld or mobile device 206 or other network-enabled computing device 208, collectively devices 209; a plurality of retail merchants, including retail merchant 234 and retail merchant 236, collectively, retail merchants 238; and one or more third party services, such as a third party location awareness service 216, a third party online retail service 218 and a third party cookie service 219, collectively, third party services 219. Further, to facilitate communication between the various components of environment 200, each component may be connected to one or more communications networks, exemplified as network 202.

It should be understood, however, that environment 200 is only one example of a suitable networked environment for implementing methods described herein and is not intended to suggest any limitation as to the scope or functionality of the present disclosure. For example, in some embodiments, there may be more or fewer devices, or components depicted in FIG. 2 may be combined to a single device. For example, retail promotional platform server 220 and one or more of databases 210 may be physically located on the same device, and still function as described herein.

As mentioned, components of environment 200 may be connected to one or more networks, such as network 202, for communication. Network 202 may be wired, wireless or a combination of wired and wireless. For example, in some embodiments, certain components may be connected to a public data network such as the public Internet. In other embodiments, some components may communicate via a wireless network such as a mobile or cellular network. In at least one embodiment, network 202 exemplifies a combination of wired and wireless, where a wireless enabled mobile device, such as mobile device 206, may communicate with retail promotional platform server 220 via both a cellular network and a public data network.

Retail promotional platform server 220 is generally representative of one or more servers suitable for processing promotional data and serving data in the form of webpages, mobile portal applications, or other related software and data structures, to service devices having various functionalities. As depicted, retail promotional platform server 220 may include processor 222 which may further include one or more processors, processing circuits, or controllers. Processor 222 may be coupled to memory 224, which stores code (machine-readable or executable instructions) for retail promotional platform server 220, as well as for processes performed by retail promotional platform server 220. In at least one embodiment, memory 224 includes promotional processing logic module 230 which may include computer-executable instructions for processing promotional information from merchants and requests for promotional information by consumers. In addition, as would be understood by those skilled in the art, retail promotional platform server 220 may include additional components for operation, such as RAM 233, ROM 232 and/or input/out mechanisms 228 (such as a keyboard, mouse, display, etc.).

Processor 222 may include one or more local or distributed processors, controllers, or virtual machines, and in at least one embodiment, is configured as a special purpose computer with promotional processing logic 230 for receiving and serving promotional data. Memory 224 may comprise one or more electronic, magnetic, or optical data-storage devices, as well as promotional processing logic 230. Promotional processing logic 230 may include machine readable and/or executable instructions sets for performing and/or facilitating performance of methods and rendering graphical user interfaces as further described herein, including sharing one or more portions of this functionality in a mobile device portal application architecture, over a wireless or wireline communications network 202 with one or more devices 209. The processing logic may be embodied in a variety of known languages as would be understood by those skilled in the art, and will be discussed in further detail herein.

Databases 210 may include one or more separate databases, such as database 212 and database 214. Further, as would be understood in the art, each of databases 210 may include one or more electronic, magnetic, optical data-storage devices, or other data-storage devices which can include or are otherwise associated with respective indices (not shown). In some embodiments, databases 210 may store promotional data submitted by retail merchants. In other embodiments, databases 210 may extract and store consumer data, such as preference data submitted by consumers or consumer purchasing information from 3^{rd} party consumer services, e.g., Amazon®. According to aspects described herein, databases 210 may be connected to server 230 via network 202.

Retail promotional platform server 220, databases 210, as well as other 3rd party services, may be accessed by one or more access devices, including, but not limited to, personal computers, workstations, handheld devices, mobile telephones, or any other device capable of providing an effective user interface with a server or database. As depicted, in at least one embodiment, various components of environment 200 are connected to personal computer 204, mobile device 206, and another network-enabled device 208, collectively access devices 209.

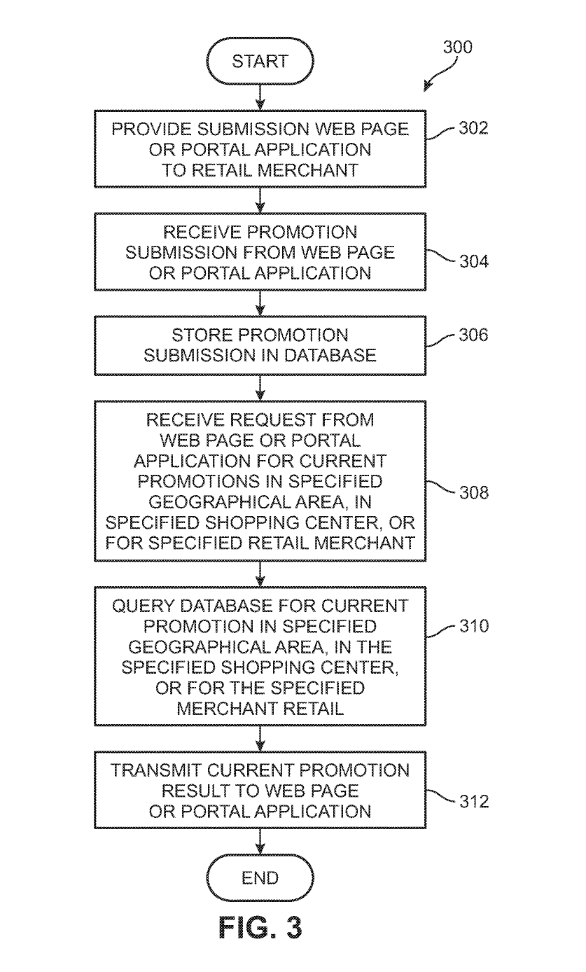

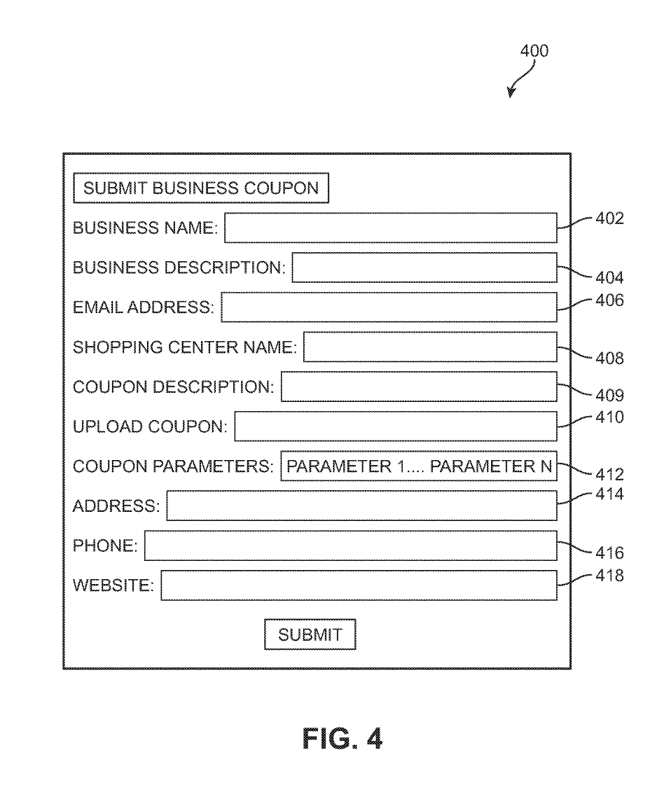

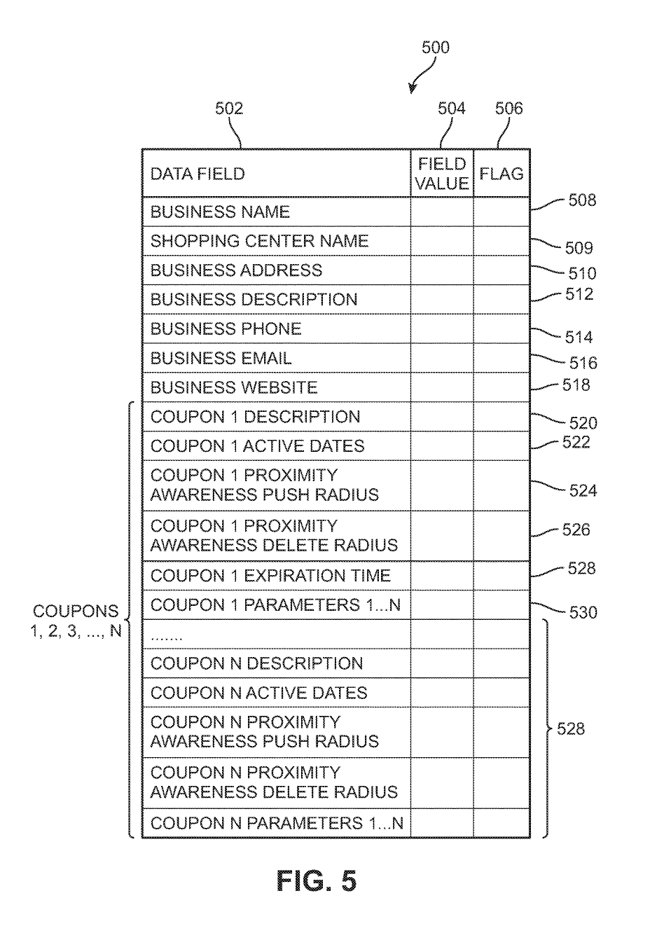

FIG. 3 depicts a flowchart 300 of a general method for disseminating promotional information according to embodiments set forth herein. At step 302, a server, such as retail promotional platform server 220, configured with promotional processing logic may provide a promotion submission user interface 400 (see FIG. 4) to a retail merchant for submission of one or more promotions for dissemination to consumers. At step 304 retail promotional platform server 220 may receive a submission of the one or more promotions from the retail merchant. After a submission is received by a retail merchant at step 304, at step 306 one or more data structures 500 (see FIG. 5) may be created which detail aspects of the one or more promotion submissions for storage in one or more databases 210. Next, at step 308, retail promotional platform server 220 may receive a request for a promotion from a consumer via a mobile portal application (see, e.g., portal application user interface 600) or a web-enabled promotional application (see, e.g., application user interface 700).

According to embodiments described herein, the request at step 308 may specify one or more search parameters. For example, in one embodiment, a consumer may be searching for a promotion in a specified geographical area, such as zip code, a proximity area defined by a radius having a specified distance from the consumer, or by any other method for searching a specified geographical area as would be understood in the art. In other cases, a consumer may be searching for a promotion in a specified shopping center or a promotion from a specified merchant. These embodiments are only exemplary, however, and it is contemplated that a retail promotional platform as described herein may encompass searching on more than one parameter at a time or based on parameters that are not specifically identified herein but would be contemplated by a skilled artisan.

At step 310, retail promotional platform server 220 may query one or more databases 210 for current promotions that match the one or more specified search parameters in step 308. Finally, at step 312, retail promotional platform server 220 may transmit, via network 202, the current promotions identified during step 310.

It should be understood that flowchart 300 presents a general process for receiving current promotions from retail merchants and then providing the relevant promotions to consumers according to only one embodiment contemplated herein. There may be other embodiments—including the additional embodiments discussed below—that follow fewer or more steps than are outlined in flowchart 300. For example, in one embodiment, retail promotional platform server 220 may simple receive an email from a retail merchant or a consumer, rather than providing a promotion submission user interface or a mobile portal application. Those skilled in the art will recognize the variety of way that the methods contemplated herein may be implemented and still fall within the spirit and scope of the present disclosure.

A “retail merchant” as referenced in flowchart 300 and as used herein may be any type of business that is vested in selling goods or providing a service to a consumer, In some cases, the retail merchant may be a standalone retailer that is not connected to other retailers, such as Restaurant A 150 in FIG. 1. In other cases, the retail merchant may be one of many tenants combined together in a shopping center, such as drug store 146 in shopping center 140. In still other cases, the retail merchant may be a shopping center manager or tenant landlord that is economically vested in a specific merchant or tenant. Similarly, the terms “promotion” and “promotional information” as used in the present disclosure should be understood to encompass any promotion, deal, coupon, discount or other business communication from a commercial establishment or retail merchant.

As presented in flowchart 300, a promotion submission user interface for use by a retail merchant, referenced at step 302, may take many forms as would be contemplated by a skilled artisan. For example, in some cases, a promotion submission user interface may be a free form submittal page. In other cases, a promotion submission user interface may have a plurality of fields into which a retail merchant will enter its data. In at least one embodiment, a retail merchant may submit a business coupon or promotion via a web-based user interface similar to promotion submission user interface 400 depicted in FIG. 4. Specifically, FIG. 4 represents an example promotion submission user interface 400 that may be used by retail merchants that are participating in a network-enabled retail promotional platform, such as retail promotional platform 100. As seen in FIG. 4, according to at least one embodiment, user interface 400 may provide data entry fields such as: business name entry field 402; business description entry field 404; email address entry field 406; shopping center name entry field 408; coupon/promotion description entry field 409; coupon/promotion upload entry field 410; coupon parameters entry field 412; business address entry field 414; business phone entry field 416; and business website entry field 418.

It is contemplated that a retail merchant may submit various parameters and/or limitations with a promotion. In some cases, parameters may be related to an active date range for a promotion. In other cases, parameters may be related to a specific date or time of expiration. In still other cases, a retail merchant might limit distribution of a promotion based on a consumer's physical proximity to the retail merchant, In still other cases, parameters may be related to a specific consumer's shopping preferences or “favorites” items as saved with a third party online retailer. Accordingly, it should be understood that the types of parameters that may be applied to a promotion are varied and that the disclosure is not limited to only those specific parameters described herein.

FIG. 5 depicts a retail merchant data record 500 that may be created and stored by retail promotional platform server 220 in databases 210 at step 306, according to at least one embodiment disclosed herein. In the embodiment, retail merchant data record 500 may have a plurality of data fields 502, and each data field 502 may have a corresponding value field 504. In addition, retail merchant data record 500 may also contain a flag field 506 for further information or groupings to be made in relation to one or more of data fields. For example, an ON/OFF condition such as turning “OFF” a proximity awareness parameter, or any other contemplated parameter, may be indicated in flag field 506. It should be understood, however, that retail merchant data record 500 shown in FIG. 5 is only exemplary, and that more or fewer fields may be present or the data record may be structured differently. In addition, a data record for a retail merchant and/or a consumer may include additional data fields not specifically set forth herein.

Based on the data that is submitted by a retail merchant during step 304, as depicted in FIG. 5, in one embodiment retail merchant data record 500 may contain one or more of the following data fields: a business name field 508; a shopping center name field 509, denoting a larger retail complex that the retail merchant may be a part of; a business address field 510; a business description field 512; a business phone field 514; a business email field 516; a business website field 518; a first coupon/promotion description field 520; a first coupon/promotion active dates field 522; a first coupon/promotion proximity awareness push radius field 524; a first coupon/promotion proximity awareness delete radius field 526; a first coupon/promotion expiration time field 528; field 530 denoting a plurality of additional first coupon/promotion parameters; and additional fields 532 denoting additional coupons/promotions stored for the retail merchant of retail merchant data record 500.

According to one or more embodiments described herein, a consumer may access the promotional information stored in retail promotional platform 100 via one or more access devices 209 that are connected to retail promotional platform 100 via one or more wireless or wireline networks. More specifically, access devices 209 may be enabled with one or more applications configured to query retail promotional platform server 220, or otherwise communicate with retail promotional platform 100.

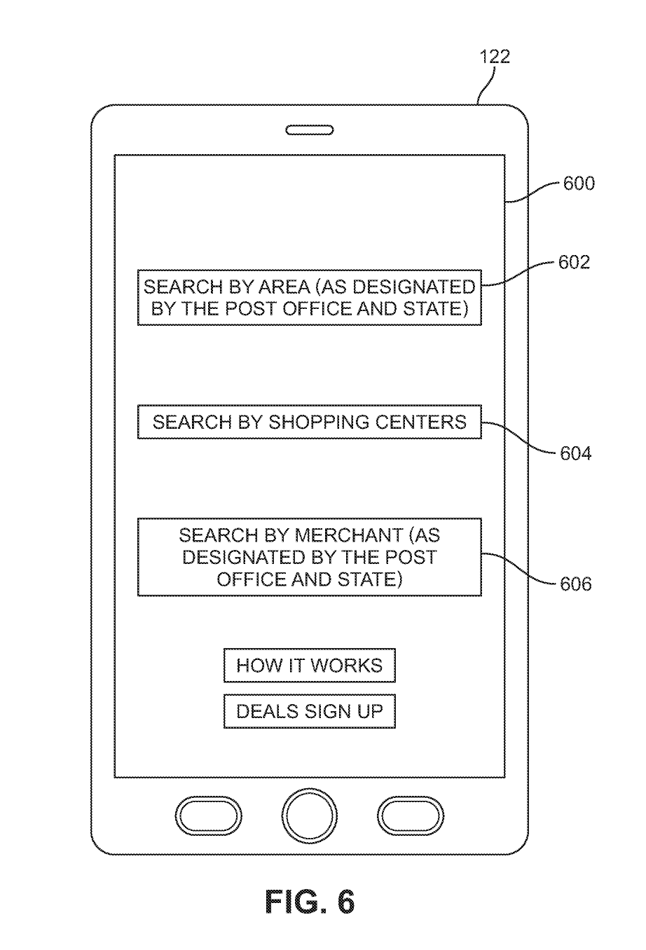

In one embodiment, a mobile consumer (e.g., consumer 120 in FIG. 1) may interact with a mobile portal application on a mobile device to access retail promotional platform 100. FIG. 6 depicts an example of a mobile device portal application user interface 600 for such interaction. In the embodiment of FIG. 6, mobile device portal application user interface 600 includes an option 602 for searching promotional information by a specific area, an option 604 for searching promotional information by a specific shopping center, and an option 606 for searching promotional information by a specific merchant. Those skilled in the art will recognize, however, that a mobile device portal application user interface may look significantly different than mobile device portal application user interface 600 and still fall within the scope of the present disclosure. In practice, a consumer may download/receive a mobile device portal application from retail promotional platform 100, having a user interface, such as mobile device portal application user interface 600, and use the application to perform queries regarding relevant promotional information.

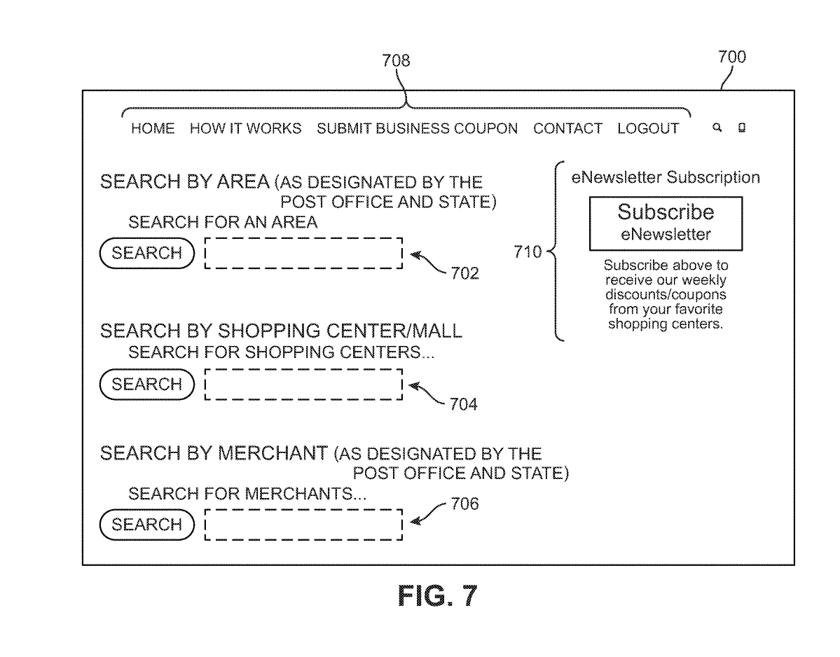

In another embodiment, a consumer may interact with a web-enabled application on a home computer (e.g., consumer 160 on computer 162 in FIG. 1) to access retail promotional platform 100. FIG. 7 depicts an example of a web-enabled application user interface 700 for such interaction. In the embodiment of FIG. 7, web-enabled application user interface 700 includes an option 702 for searching promotional information by a specific area, an option 704 for searching promotional information by a specific shopping center, and an option 706 for searching promotional information by a specific merchant. In addition, web-enabled application user interface 700 may include additional browsing options 708, for browsing information about retail promotional platform 100. Web-enabled application user interface 700 may also include additional services, such as an newsletter service 710. Again, those skilled in the art will recognize that a web-enabled application user interface may look significantly different than the web-enabled application user interface 700 and still fall within the scope of the present disclosure. In practice, a consumer may load web-enabled application user interface 700 on any well-known Internet browser, and use the application to perform queries to retail promotional platform 100 regarding relevant promotional information.

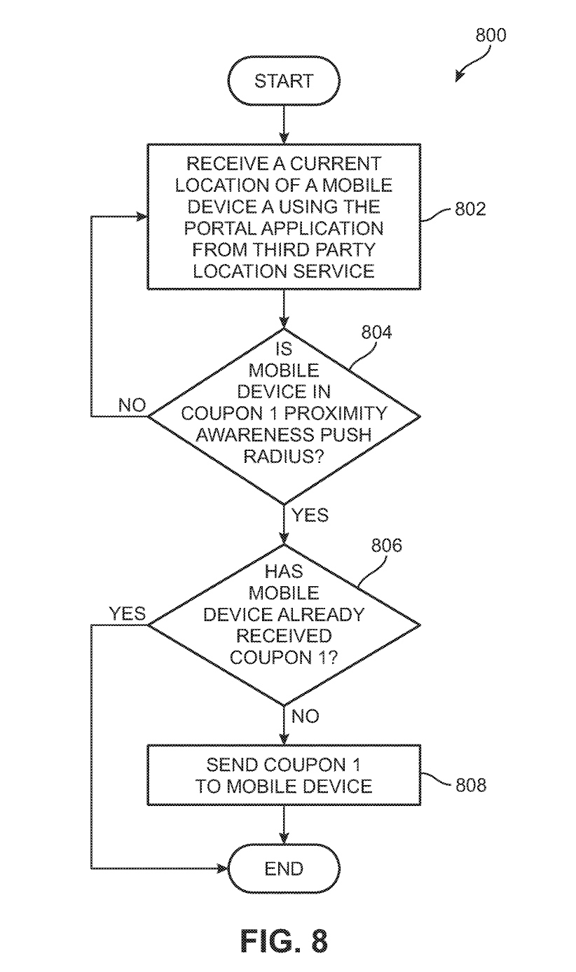

Retail promotional platform 100 may also be configured to receive information from one or more third party web-enabled services to facilitate matching promotional information to a specific consumer. In some cases, retail promotional platform server 220 and/or one or more access devices 209 may communicate with a third party location awareness service 216 to receive information regarding the consumer's location, via the location of the one or more access devices. For example, a third party location awareness service 216 may receive information regarding the location of a consumer's access device and may use the location information to provide promotional information that is relevant to the consumer's locations. In addition, retail promotional platform server 220 may be configured to push promotions to the consumer that are in specified proximity to the consumer's location and subsequently delete promotions once the consumer moves out of a specified proximity. These and other embodiments will be discussed later in relation to FIGS. 8-12.

In other cases, retail promotional platform server 220 and/or one or more access devices 209 may communicate with a third party retail web service 217, e.g. Amazon.com®, or a third party web cookie service 218, e.g. DoubleClick®, to receive information a consumer's online purchases or browsing habits. For example, retail promotional platform server 220 may receive information about one or more items that a consumer may have saved in an online “shopping cart” or “wishlist” from a third party retail web service 217. Or, retail promotional platform server 220 may receive information about items that a consumer is viewing via its browsing history from a third party web cookie service 218. With this information, retail promotional platform server 220 may be configured to push, to the consumer's device, promotions that are related to the saved or browsed items and that are convenient to the consumer's current location.

The following examples and embodiments are exemplary of the types of scenarios that may be addressed with the methods and systems set forth in the present disclosure. It should be understood and appreciated by a skilled artisan that the following examples are in no way limiting to the breadth and the scope of the various embodiments contemplated herein, nor are they comprehensive in terms of the types of interaction that may occur between consumers, retail merchants, and retail promotional platform 100.

### EXAMPLE 1

Referring to FIG. 1 and the method described in the flowchart of FIG. 3, during one example interchange with retail promotional platform 100, consumer 120 may be on foot or otherwise in transit, and may be interested in finding promotions for a next meal. As such, consumer 120 may search retail promotional platform 100 via a portal application on mobile device 122, such as that embodied by mobile device portal application user interface 600. In the following examples, retail promotional platform 100 may also receive information about the location of mobile device 122 through a location awareness service, e.g. third party service 216, as would be known in the art.

In a first scenario referring to FIG. 1, consumer 120 may want to go to a specific restaurant, and may query retail promotional platform 100 for promotions related to “Restaurant A” at step 308. Accordingly, retail promotional platform 100 may query (step 310) and send (step 312) to mobile device 122 only those promotions that relate to Restaurant A 150, three miles away from consumer 120, and Restaurant A 134, one-half miles away from consumer 120. Thus, even though restaurant 144 is closer to consumer 120, at 2 miles away, than Restaurant A 150, at 3 miles away, consumer 120 may not receive promotional information about restaurant 144 during a query on specific retailer, “Restaurant A.”

### EXAMPLE 2

In a second scenario referring to FIG. 1, however, consumer 120 may be walking and interested in going to a restaurant in a specific geographical area. Consumer 120 may query retail promotional platform 100 for promotions within 2 miles of his current location. Accordingly, retail promotional platform 100 may query (step 310) and send (step 312) to mobile device 122 only those promotions that relate to restaurant 144, two miles away from consumer 120, and Restaurant A 134, one-half miles away from consumer 120. Consumer 120 would not receive promotional information about Restaurant A 150, at three miles away.

### EXAMPLE 3

Again, referring to FIG, 1 and the method described in the flowchart of FIG. 3, during another example interchange with retail promotional platform 100, consumer 160 may be on home computer 162, and interested in finding promotions for a shopping trip to shopping center 130. As such, consumer 160 may search retail promotional platform 100 via a web-enabled application on home computer 162, such as that embodied by web-enabled application user interface 700.

In the scenario, consumer 160 may be planning to attend a fitness class at fitness studio 138, and then stay after for a shopping trip at shopping center 130. Accordingly, consumer 160 may query retail promotional platform 100 for current promotions at any of the retail merchants in shopping center 130. Retail promotional platform 100 may query (step 310) and send (step 312) to home computer 162 only those promotions that relate to shopping center 130 or to any of the retail merchants in shopping center 130.

### EXAMPLE 4

As previously introduced, retail promotional platform 100 may also be configured to push—i.e., to automatically send to an access device even if the device did not explicitly make a request—promotional information to a consumer that is located within a minimum geographical area from one or more retail merchants having promotional information to share. In particular, in at least one embodiment, retail promotional platform 100 may receive parameters from a retail merchant to automatically send information to any consumer having a promotional information portal application on a mobile device if that consumer enters a geographical area having a pre-determined radius around the particular retail merchant. In other cases, a consumer may send retail promotional platform 100 instructions to push promotional information to a consumer's device if a particular retail merchant uploads a promotion. In such cases, the consumer may instruct retail promotional platform 100 to push the particular merchant's promotion if the consumer enters a pre-determined geographical area near the merchant, or the consumer may instruct retail promotional platform server 220 to push the promotion regardless of the consumer's location. In still other cases, either the consumer or the retail merchant could instruct retail promotional platform server 220 to push a promotion based on other parameters related to either the consumer, the retail merchant or a particular item or service that is being promoted.

FIG. 8 depicts a flowchart of a method of dissemination, and in particular, pushing, promotional information, according to at least one embodiment set forth herein. According to the flowchart 800, when a consumer having a mobile device with a retail promotional platform portal application enters a proximity awareness push radius for a retail merchant, retail promotional platform server 220 may send coupon 1 to the consumer's mobile device.

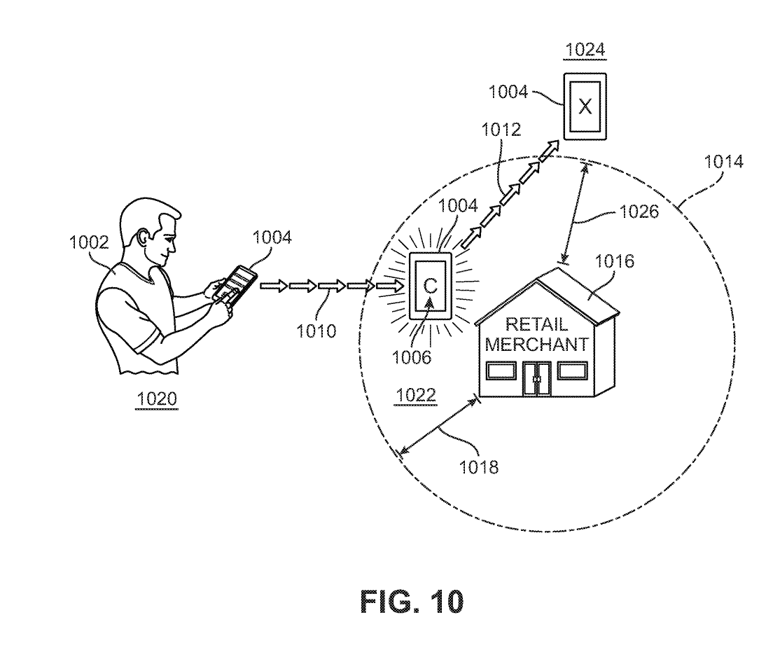

FIG. 10 depicts an example of the method outlined in flowchart 800. Referring to FIG. 10, consumer 1002 has a mobile device 1004 having a retail promotional platform portal application, such as that partially depicted in FIG. 6. Further, in the example of FIG. 10, retail merchant 1016 may have a promotion 1006, that it wants to push to consumers that are connected to retail promotional platform 100 when a consumer enters a proximity awareness push radius 1018, e.g., ½ mile, from the location of retail merchant 1016.

Consumer 1002 may initially be located at location 1020, more than proximity awareness push radius 1018. At step 802, retail promotional platform server 220 may receive a location of mobile device 1004 via a third party location awareness service 216. At step 804, retail promotional platform server 220 may determine that mobile device 1004, in location 1020, is not within proximity awareness push radius 1018, and thus will continue looping through step 802. As consumer 1002 moves along path 1010 to location 1022, however, retail promotional platform server 220 may determine that mobile device 1004, in location 1022, is within proximity awareness push radius 1018. Accordingly, at step 806, retail promotional platform server 220 may determine whether mobile device 1002 has already received promotion 1006 from retail merchant 1016. If mobile device 1002 has not received promotion 1006, retail promotional platform server 220 may push promotion 1006 to mobile device 1002 at step 802.

Retail promotional platform 100 may also be configured to facilitate efficient mobile device operation. In some cases, retail promotional platform server 220 may be configured to remove or delete expired promotions, or promotions that are no longer relevant. For example, promotion 1006, previously pushed and saved to one or more mobile access device portal applications, may be deleted to free up valuable storage space on mobile device 1004 or other access device. In other cases, a portal application on an access device, such as a mobile device portal application, may be configured to automatically remove or delete expired or non-relevant promotions.

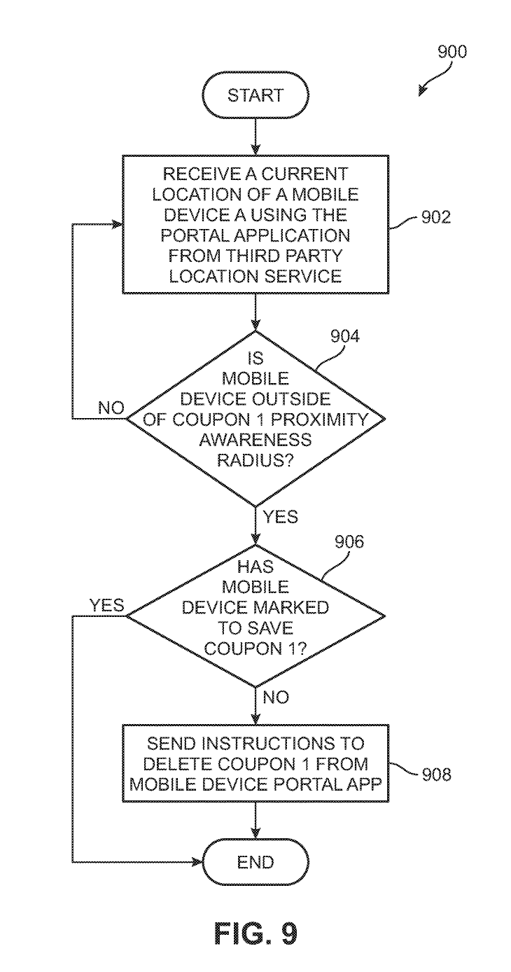

In at least one case, retail promotional platform server 220 may be configured to delete a previously delivered promotion from a consumer's mobile device when the promotion is no longer relevant. FIG. 9 depicts a flowchart 900 of a method of deleting promotional information that is no longer relevant, according to at least one embodiment set forth herein.

FIG. 10 also depicts an example of the method outlined in flowchart 900. Referring again to FIG. 10, consumer 1002 having mobile device 1004 has now entered proximity awareness push radius 1018, and has received promotion 1006 at location 1022. At step 902, retail promotional platform server 220 may again receive a location of mobile device 1004 via a third party location awareness service 216. At step 904, retail promotional platform server 220 may determine that mobile device 1004, in location 1022, is within proximity awareness delete radius 1026, and thus will continue looping through step 902. Proximity awareness delete radius may be any distance, e.g. mile, as determined by retail merchant 1016 or retail promotional platform 100, and may signify a distance from retail merchant 1016 where promotion 1006 is no longer relevant to consumer 1002.

Thus, as consumer 1002 moves along path 1012 to location 1024, retail promotional platform server 220 may determine that mobile device 1004, in location 1024, is outside of proximity awareness delete radius 1026. Accordingly, at step 906, retail promotional platform server 220 may determine if consumer 1002 intends to save promotion 1006. If consumer 1002 has not saved promotion 1006, at step 908, retail promotional platform server 220 may send instructions to a retail promotional portal application on mobile device 1004 to delete promotion 1006 from mobile device 1004. Deleting promotion 1006 when it is no longer relevant to the consumer may save memory and enhance the performance of mobile device 1004.

### EXAMPLE 5

Retail promotional platform 100 may also be configured to push promotional information that is aligned with a consumer's online shopping habits. In one embodiment, a consumer may send retail promotional platform 100 instructions to push promotional information to a consumer's device if a specific item or type of item has a promotion associated with it. For example, in some cases, retail promotional platform 100 may interact with a both a third party online retailer and a retail merchant having a promotion to send a price comparison on a specific item. In at least one case, retail promotional platform 100 may be configured to query one or more third party services, such as a third party retail web service 217 or a third party web cookie service 218, to receive information about items that the consumer is currently shopping for or frequently views at online retailers.

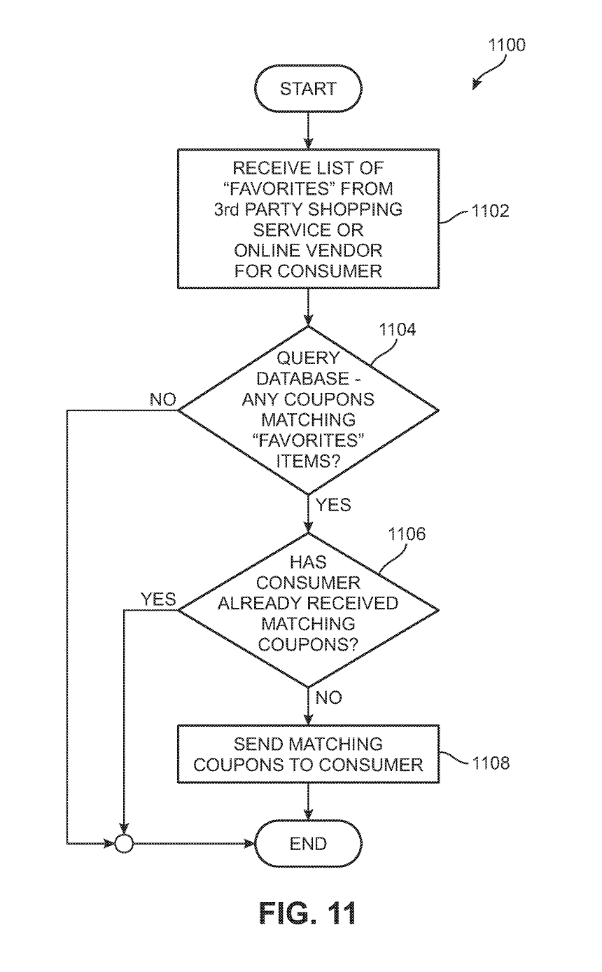

FIG. 11 depicts a flowchart of a method of pushing promotional information, according to another embodiment set forth herein. According to flowchart 1100, when retail promotional platform 100 determines that there are promotions matching a consumer's shopping items or “favorites,” retail promotional platform server 220 may send the one or more relevant promotions to the consumer's mobile device. In particular, at step 1102, retail promotional platform server 220 may interact with one or more third party services, such as third party retail web service 217 or third party web cookie service 218 to first receive a list of a specific consumer's “favorites” items, a list of items currently in an online shopping cart, or information about items that a consumer has been recently viewing at online retailers. At step 1104, retail promotional platform server 220 may query databases 210 to determine if that are any current promotions that are relevant to the items discovered in step 1102. If relevant promotions are found, at step 1106, retail promotional platform server may determine if the consumer has already received the one or more relevant promotions. If the consumer has not received the one or more relevant promotions, at step 1108, retail promotional platform server 220 may forward the relevant promotions to a consumer's access device.

### EXAMPLE 6

Retail promotional platform 100 may also be configured to deliver one or more temporal-based promotions to consumers. For example, in one embodiment, retail promotional platform 100 may deliver a promotion that lasts for only a short period of time, such as a specified one-hour window. In other cases, retail promotional platform 100 may deliver a promotion having a longer life, but with a pre-determined expiration date. Further, in still other embodiments, a temporal-based promotion may have a variety of parameters associated with it related to how to deliver and to whom the temporal-based promotion should be delivered. For example, in some cases, the temporal-based promotion may further indicate a proximity awareness radius from the retail merchant, indicating a geographical area of relevant consumers for the temporal-based promotion.

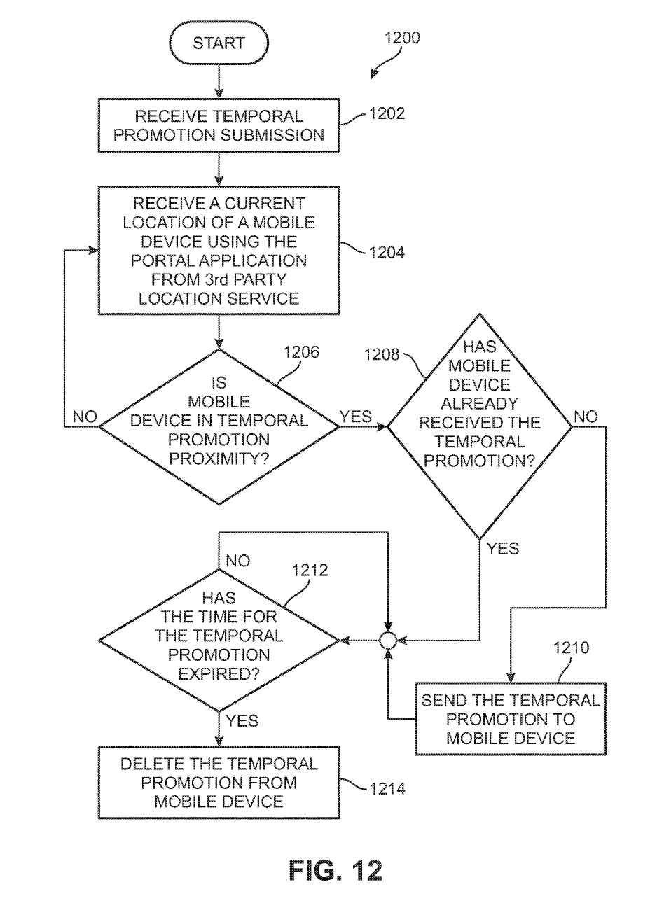

In at least one embodiment, retail promotional platform 100 may be configured to push a relevant temporal promotion to a consumer in a specified geographical area, and then subsequently delete the temporal promotion when the timeframe set for the temporal promotion expires. FIG. 12 depicts a flowchart 1200 of a method of pushing promotional information, and specifically a temporal-based promotion, according to one or more embodiments set forth herein. At step 1202, retail promotional platform server 220 may receive a temporal-based promotion from a retail merchant. As previously discussed, the temporal-based promotion may have a variety of parameters associated with it, including a specific time frame within which the temporal-based promotion may be available as well as a promotion proximity area in which the retail merchant would like the temporal-based promotion distributed. At step 1204, retail promotional platform server 220 may receive a location of a mobile device via a third party location awareness service 216. Next, at step 1206, retail promotional platform server will determine if the mobile device is within the specified temporal-based promotion proximity. If the mobile device is not with the specified temporal-based promotion proximity, the method will continue looping through step 1204. If retail promotional platform server 220 determines that the mobile device is in a location that is within the specified temporal-based promotion proximity, the method will move to step 1208.

At step 1208, retail promotional platform server 220 will determine whether mobile device has already received the temporal-based promotion. This determination may include reviewing the promotions sent to mobile device and/or any associated flags in a data record for the mobile device or the temporal-based promotion. If retail promotional platform server 220 determines that the mobile device has not yet received the temporal-based promotion, at step 1210, retail promotional platform server 220 will send the temporal-based promotion to the mobile device. The method will then continue to step 1212, described below.

If, at step 1208, retail promotional platform server 220 determines that the mobile device has received the temporal-based promotion, the method progresses to step 1212 where retail promotional platform server 220 may determine if the time has expired for the temporal-based promotion. If retail promotional platform server 220 determines at step 1212 that the time has not expired for the temporal-based promotion, the method may continue to loop through step 1212. If retail promotional platform server 220 determines that the the time has expired for the temporal-based promotion, the method may proceed to step 1214 and retail promotional platform server 220 may delete or send instructions to the mobile device to delete the expired temporal-based promotion.

Those skilled in the art will readily understand that the embodiments described herein are only exemplary, and that many variations and combinations of the embodiments are possible. As one example, the concept of deleting promotions that are no longer relevant to a consumer, as described in the embodiment of FIG. 9, may be applied to other embodiments, such as the embodiment described in FIG. 11. Thus, while various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method for disseminating promotional information to a consumer over a communication network, the method comprising:
receiving, by a server configured to process promotional data as part of a promotional information dissemination system, at least one promotion, wherein the at least one promotion is associated with a retail merchant and a first parameter;
storing, by the server in a searchable database connected to the promotional information dissemination system, the at least one promotion, the associated retail merchant and the first parameter;
receiving, by the server, a query for retail promotional information from an access device configured to interact with the promotional information dissemination system; and
searching, by the server, the searchable database based on the query; and
sending, by the server, the at least one retail promotion to the access device.

2. The method of claim 1, wherein the query comprises a search request based on the retail merchant.

3. The method of claim 1, wherein the query comprises a search request based on the first parameter.

4. The method of claim 1, wherein the query comprises a search request based on a first location.

5. The method of claim 4, wherein the first location is a location area associated with the retail merchant.

6. The method of claim 4, wherein the first location is a location area associated with the access device.

7. The method of claim 1, wherein the access device is a mobile device configured with a portal application, the portal application being in communication with the promotional information dissemination system, and wherein the step of sending the at least one retail promotion to the access device comprises sending the at least one retail promotion to the portal application.

8. The method of claim 7, wherein the first parameter is an expiration time for the at least one promotion, and wherein the method further comprises:
deleting, by the server, the at least one promotion from the portal application if the expiration time has passed.

9. A system for disseminating retail promotional information to a consumer, the system comprising:
a retail promotional system portal application, executing on a mobile device of a consumer;
a retail promotional system database; and
a retail promotional system server in network communication with the retail promotional system portal application and the retail promotional system database, and wherein the retail promotional system server is configured to:
receive data related to the consumer;
send, to the retail promotional system portal application, a promotion, based on the data related to the consumer;
determine whether an event has happened for the promotion to be deleted; and
based on the determination, delete the promotion from the retail promotional system portal application if the event has happened.

10. The system of claim 9, wherein the data related to the consumer comprises a current location of the consumer.

11. The system of claim 9, wherein the data related to the consumer comprises a buying preference of the consumer.

12. The system of claim 10, wherein the event comprises a consumer moving out of a relevant location for the promotion.

13. The system of claim 11, wherein the event comprises a change to the buying preference of the consumer.

14. The system of claim 9, wherein the promotion includes an expiration time, and wherein the event comprises passing the expiration time.

15. A method for disseminating promotional information to a consumer over a communication network, the method comprising:
receiving from a web-based service, by a retail promotional system server, data related to a consumer, wherein the consumer has access to a retail promotional system portal application on a mobile device;
determining, by the retail promotional system server, that a promotion is relevant to the consumer based on the data related to the consumer;
sending to the retail promotional system portal application, by the retail promotional system server, the promotion that is relevant to the consumer;
determining, by the retail promotional system server, whether an event has happened for the promotion to be deleted; and
based on the determining, deleting, by the retail promotional system server, the promotion from the retail promotional system portal application if the event has happened.

16. The method of claim 15, wherein the web-based service comprises a location awareness service, and wherein the data related to the consumer comprises a current location of the consumer.

17. The method of claim 15, wherein the web-based service comprises an online retailer, and wherein the data related to the consumer comprises a buying preference of the consumer.

18. The method of claim 17, further comprising:
receiving, by the retail promotional system server, a retail price for the buying preference of the consumer;
comparing, by the retail promotional system server, the retail price for the buying preference of the consumer to a price for the promotion; and
sending, to the retail promotional system portal application, by the retail promotional system server, the price comparison.

19. The method of claim 16, wherein the event comprises a consumer moving out of a relevant location for the promotion.

20. The method of claim 17, wherein the event comprises a change to the buying preference of the consumer.

21. The method of claim 15, wherein the promotion includes an expiration time, and wherein the event comprises passing the expiration time.
